(19) United States
(12) Patent Application Publication
(10) Pub. No.: US 2025/0330113 A1
(43) Pub. Date: Oct. 23, 2025

(54) Hybrid Solar Panel and Photovoltaic and Thermal Roof

(71) Applicant: SIC Divisione Elettronica S.r.l.u., Lecce (LE) (IT)

(72) Inventor: Jorge Miguel AGUGLIA, Lecce (LE) (IT)

(21) Appl. No.: 18/863,982

(22) PCT Filed: May 8, 2023
(86) PCT No.: PCT/EP2023/062104

§ 371 Date: Nov. 7, 2024

(30) Foreign Application Priority Data
May 9, 2022 (IT) 102022000009476

(51) Int. Cl. H02S 20/25; F24S 20/69; F24S 25/00; F24S 25/61; H02S 20/24; H02S 40/10; H02S 40/38; H02S 40/44

(52) U.S. Cl. CPC H02S 20/25; F24S 20/69; F24S 25/61; H02S 40/10; H02S 40/44; F24S 2025/804; H02S 20/24; H02S 40/38

(57) ABSTRACT

A hybrid-type solar panel comprising a structure suitable for making a photovoltaic panel, a thermal panel, a watertight roof, an electric storage, all integrated in a basic structure (20). A roof for a house is also provided.

### TECHNICAL FIELD

Present invention relates, in general to a hybrid-type solar panel arranged to realize a photovoltaic and thermal panel and a photovoltaic and thermal roof.

The present invention is also configured to accommodate on-board an electrical storage apparatus.

### BACKGROUND ART

Solar panels are known in which a photovoltaic panel is coupled to a thermal panel.

These solar panels are generally called hybrid-type solar panels or hybrid solar panels and are suitable for converting solar radiation into electrical and thermal energy.

For example, from the publication WO2010/128462_A2 in the name of the Applicant, a hybrid solar panel is known consisting of a basic structure, made of aluminum, on which a set of photovoltaic cells is fixed, and that internally comprises a liquid that flows so as to capture the solar heat energy captured by the panel.

Applicant has noted that said panel is made by gluing a protective glass directly onto the upper surface of the photovoltaic cells. This technique shows an important problem of dispersion of the heat captured by the upper surface, due to the absence of a layer of thermal insulation.

Moreover, according to the prior art and also to others, it is provided that, in case of installation of panels of the same type, these are installed in contact with each other and perfectly aligned.

The Applicant has noted that, in case of installation of several panels in contact with each other, there are problems of dirt and rainwater infiltration between panel and panel.

In fact, the juxtaposition and joining of the known hybrid panels generally shows problems of stagnation of dirt and rainwater, in particular at the joining areas of the panels.

According to the prior art, electric accumulators for solar applications are composed of a dedicated and calibrated device for the various systems, and require separate installation; further-more they often have to be accompanied by additional equipments, such as dedicated inverters for example. In the more frequent installations, this aspect leads to logistical problems, as well as to additional costs.

In general, Applicant has noted that the structure of the known hybrid panels shows some problems which cannot be easily solved except by modifying the structure of the known hybrid panels with an overall view.

### DISCLOSURE OF THE INVENTION

The invention is defined by the attached claims.

Object of the present invention is to solve the above-mentioned problems of the known art and other problems which have not yet been solved by significantly intervening on the structure of the hybrid panels known up to now.

The object is achieved by way of the structure for a hybrid solar panel having the characteristics referred to in the claims that follow.

Claims as well as the description and the figures form an integral part of the technical teaching provided here regarding the invention.

The following summary of the invention is provided in order to provide a basic understanding of some aspects and features of the invention.

This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

According to a feature of a preferred embodiment of the present invention, the hybrid solar panel structure is configured to form both a modular structure and a supporting structure arranged to replace a house roof.

According to a further fetaure of the present invention, the structure is configured so as to provide for a significant height difference between the support surfaces of the photovoltaic cells and the protective glass.

This technical feature makes it possible to create an insulating air chamber between the cells and the protective glass.

According to another feature of the present invention, the hybrid solar panel structure is configured so as to realize a significant difference in height between outer side surfaces of the panel.

This structural configuration is arranged to make the hybrid panels partially stackable to each other, when installed side by side, and to create a perfectly watertight roof.

Acording to another feature of the present invention, the basic structure of the hybrid panel is configured to house, in a fully integrated manner, at least one or more insulation panels, a set of storage batteries and a container for electrical components.

### BRIEF DESCRIPTION OF DRAWINGS

These and further features and advantages of the present invention will appear more clearly from the following detailed description of a preferred embodiment, provided by way of a non-limiting example with reference to the attached drawings, in which components designated by same or similar reference numerals indicate components having same or similar functionality and construction and wherein:

FIG. 1a shows a front view of a hybrid panel structure and a hybrid panel;

FIG. 1b shows a rear view of the hybrid panel structure of FIG. 1a;

FIG. 2 shows a front perspective view of constructional elements of the hybrid panel structure and of the hybrid panel;

FIG. 3 shows a side view of the hybrid panel structure;

FIG. 4 shows a sectional side view of a pair of hybrid panels and of their structures;

FIG. 5 shows a sectional side view of a pair of hybrid panels and of their structures, installed on a surface with a predetermined inclination.

Within this description it is provided that the figures are not necessarily to scale and that terms such as: upper, lower, longitudinal, orthogonal, frontal, back, lateral, above, below, etc. are used in their conventional meaning unless otherwise suggested.

### BEST MODE FOR CARRYING OUT THE INVENTION

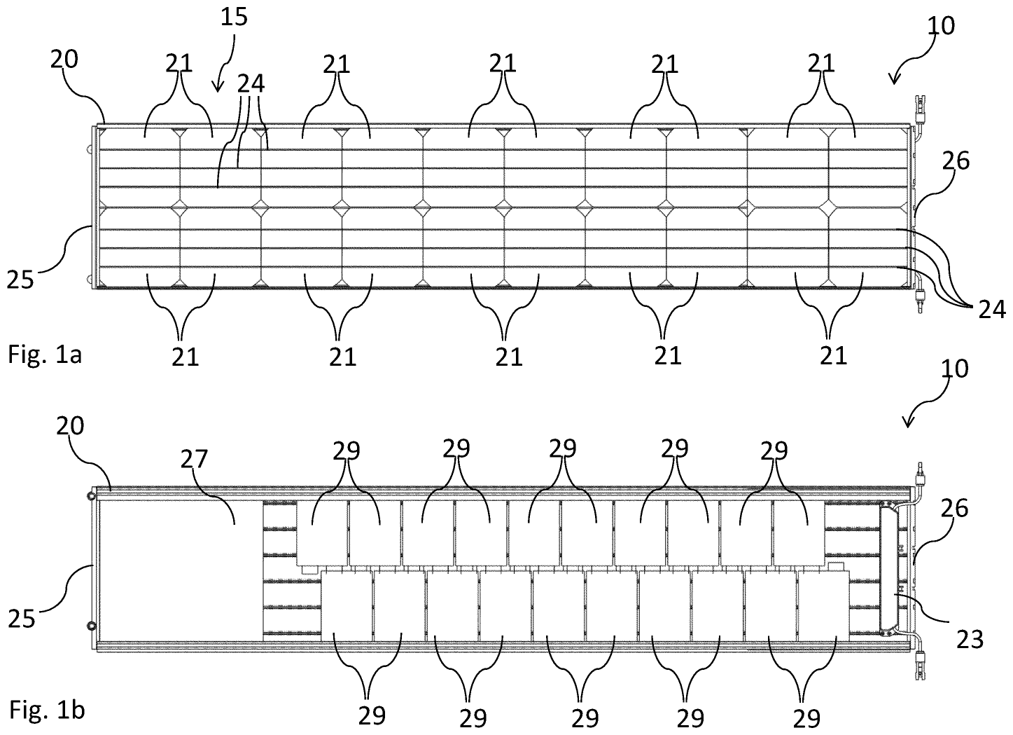

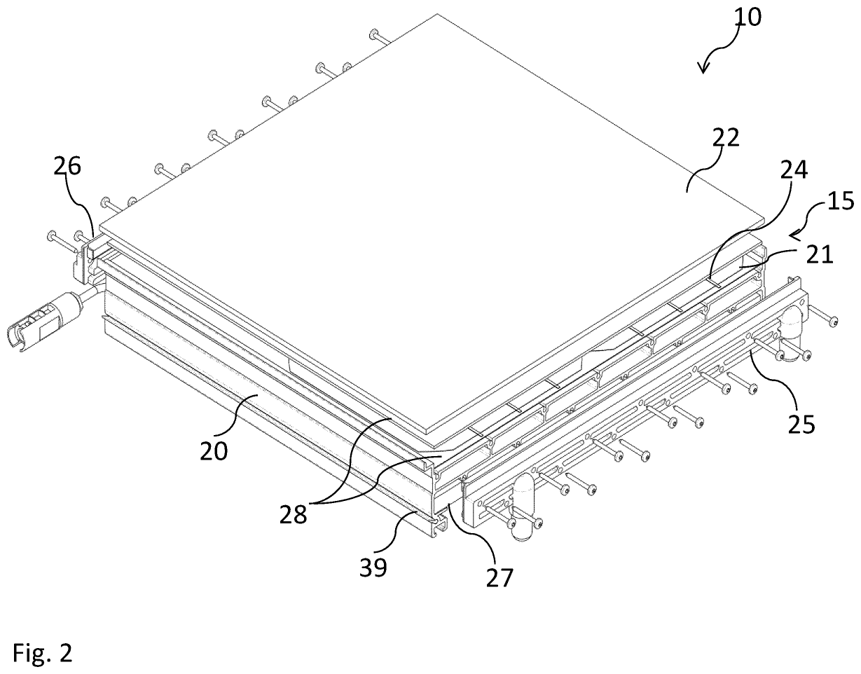

With reference to FIGS. 1a, 1b and 2, a hybrid panel 10 of predetermined length, for example between 1 m and 6 m, is configured to realize a photovoltaic panel and a thermal panel at the same time and comprises a hybrid panel structure 20, hereinafter referred to as base structure, a set of photovoltaic cells 21, in a predetermined number, for example between 10 and 100 cells, respectively comprising electrical connections 24, hereinafter referred to as a set of photovoltaic strings 15.

The hybrid panel 10 also comprises a protective glass 22, for example a protective glass made of highly transparent tempered glass, a hydraulic manifold 25, preferably made of polymeric material, for example polymeric material reinforced with glass fibers, an electrical manifold 26, also preferably made of polymeric material reinforced with glass fibers, and one or more insulation panels 27.

Preferably, the hydraulic manifold 25 and the electrical manifold 26 are positioned, in a known manner, in front of the panels in opposite positions.

The hydraulic manifold 25 is configured so as to be connected to a plurality of channels 55 obtained, in a known way, in the base structure 20 and configured to allow the flow of a heat transfer liquid inside the thermal panel.

The hybrid panel 10 also preferably comprises an electrical storage 29, for instance a set of electric storage batteries in a predetermined number, for example between 2 and 100, connected to a container for electrical components 23, in which it is provided to house, for example, an electronic circuit and an electrical storage 29.

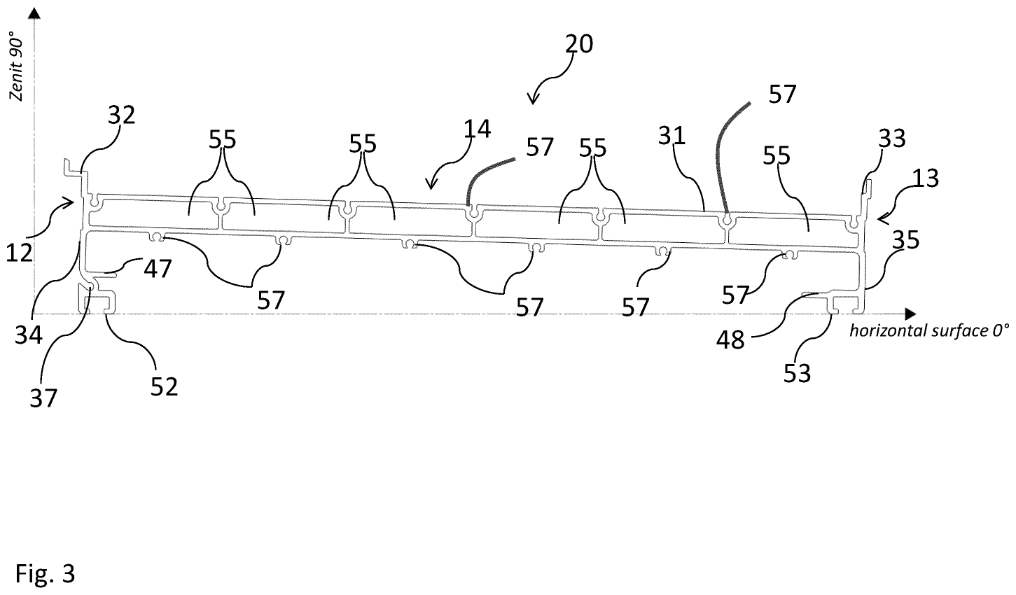

The base structure 20, in accordance with the preferred embodiment, further comprises a plurality of channels 57 (FIG. 3) which are made along the entire length of the panel 10, said channels are configured to anchor various components already mentioned, such as for example the hydraulic manifold 25, the electrical manifold 26, the container for the electronic circuits 23, the electrical storage 29, the insulation panels 27 and any additional accessorial component.

The base structure 20 comprises a front face 31 on which the photovoltaic strings 15 are fixed for example by way of one or more layers of insulating material 28, such as for example insulating material of the polymeric or silicone type.

The base structure 20 is arranged to realize a load-bearing structure for a modular type hybrid panel 10 with a substantially rectangular shape.

The base structure 20 is preferably made of aluminum alloy, for example an aluminum alloy of 6060 type, resistant to high temperatures, and is obtained by extrusion.

Of course, according to other embodiments, the base structure 20 can be made by way of other processes of known type, for example by a pultrusion process, known per se, and by way of other materials, for example by way of plastic materials with high thermal and mechanical resistance, without thereby departing from the scope of what is described and claimed.

As below specified, the base structure 20 is configured so as to be arranged to create, thanks to its rigidity characteristics, also a watertight self-supporting roof of a house.

The base structure 20, according to the preferred embodiment, shown in a side view in FIG. 3, comprises, to the left of FIG. 3, a first side 12, here referred to as the left side, and to the right of FIG. 3, a second side 13, here referred to as the right side, having different heights as to a horizontal surface.

In particular, it is provided that the left side 12 comprises a first upper shelf or upper left shelf 32 and that the right side 13 comprises a second upper shelf or upper right shelf 33, whereby the shelves are mutually at different heights as to a horizontal reference surface and that the brackets 32 and 33 shape an inclined support surface as to the horizontal surface for the protective glass 22 (FIG. 2, FIG. 3).

More in particular, the base structure 20 comprises on the left side 12 a left support 52 and on the right side 13 a right support 53 comprising respective inverted “U” profiles. The height between the upper left shelf 32 and the left support 52 is greater than the height between the upper right shelf 33 and the right support 53. Thanks to this characteristic, the base structure 20 is configured so as to provide a difference in height between the first side 12 and the second side 13, providing to the base structure 20 and, consequently, to the hybrid panel 10 an intrinsic slope, for example a slope between 1° and 5°.

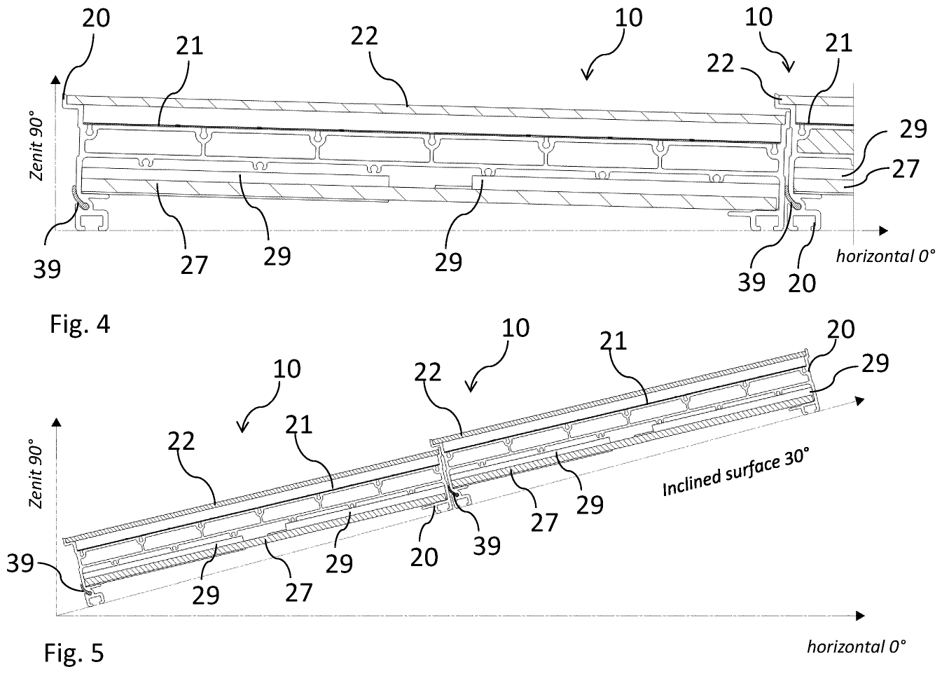

The base structure 20, as disclosed, by comprising the left and right sides 12 and 13, at different heights as to a horizontal reference surface, ensures that in case of side-by-side assembly of the hybrid panels 10, the highest side, for example the left side 12 of the hybrid panel 10 positioned on the right in the figures (FIG. 3, FIG. 4, FIG. 5), overhangs the panel positioned on the left in the figures, by a height comprised, for example, at least between 2 and 7 mm, so as to create, in any assembly condition, a tile-shaped slide for rainwater precipitation or for any dirt deposited, over time, on the protective glass 22 of each hybrid panel.

Preferably, according to the disclosed embodiment, it is provided that, by considering that the panels are usually installed with slopes for example between 10° and 90°, the side-by-side positioning of the hybrid panels 10 is such as to prevent that the photovoltaic string 15 of the adjacent hybrid panel, in the lower position, is not screened, even partially, by the hybrid panel in the upper position, in particular by the upper left shelf 32.

According to the preferred embodiment, the upper left shelf 32 and the upper right shelf 33 are raised as to the front face 31 of the base structure 20 by a preferably identical predetermined height, for example by a height between 7-15 mm.

In particular, the elevation of the shelves, 32 and 33, is configured in such a way as to create a separation space 14 (FIGS. 2-5) arranged to provide, for example, an air chamber.

The separation space 14 is configured both to house the photovoltaic strings 15 and one or more layers of insulating material 28, and to create, for example, the air chamber between the front face 31 and the protective glass 22.

In particular, the separation space 14 as a whole is configured so as to reduce the thermal dispersions of the hybrid panel 10 towards the outside and, therefore, to ensure the preservation of the captured heat, in particular inside the hybrid panel.

As a matter of fact, advantageously, the separation space 14 is arranged to create a clear decoupling among surfaces of different materials and the protective glass 22, by ensuring the absence of residual stresses which could arise from a close contact of the different materials with the protective glass 22 made of materials having different mechanical and thermal characteristics.

According to one embodiment it is provided that the base structure 20 comprises a first side wall or left side wall 34 and a second side wall or right side wall 35 configured so as to create a configuration of the panel which is very mechanically resistant.

This configuration is arranged to allow the hybrid panel 10 both to support, in addition to its own weight, also the addition of any other loads, such as for example wind, rain and snow, and to autonomously constitute a self-supporting roof.

According to this embodiment, a cavity 37 is comprised in the left side wall 34 that is suitable for receiving a gasket 39, such as for example a lip-shaped silicone gasket, so as to ensure a final barrier against any infiltrations of water between adjacent hybrid panels and to ensure the creation of a completely watertight self-supporting surface, such as for example a surface suitable for making a self-supporting roof.

According to this embodiment, it is provided that each hybrid panel can be fixed by way of screws and/or brackets housed in the inverted “U” profiles 52 and 53 to the crosspieces of a roof.

According to the preferred embodiment, two support shelves are made in a lower area of the base structure 20, respectively a left support shelf 47 and a right support shelf 48.

The shelves 47 and 48 are configured so as to house, for example, one or more insulation panels 27, one or more polyester plates of predetermined height, the set of storage batteries 29 and the container for electrical components 23 in which suitable components and electronic circuitry are located.

Advantageously, the base structure 20 is therefore configured to comprise, in accordance with this embodiment, a set of storage batteries, such as for example a storage apparatus, avoiding the presence near the hybrid panel 10 of a further container configured to comprise a set of storage batteries.

Therefore, by installing the hybrid panel 10, an electric storage is also installed comprising the management system thereof.

In the other embodiments of the present invention, when the basic structure 20 is used only for the purpose of a self-supporting roof, the hybrid panel 10 may not provide for the presence of some elements, such as for example the set of electric storage batteries and of some electronic devices.

Of course, obvious changes and/or variations to the above disclosure are possible, as regards dimensions, shapes, materials, components and connections as well as details of the disclosed construction without departing from the scope of the invention as defined by the claims that follow.

1. A hybrid type solar panel (10) characterized in that it comprises a basic structure (20) with a rectangular shape, comprising
a first side (12) comprising a first upper shelf (32),
a second side (13) opposite to the first side (12) and comprising a second upper shelf (33),
wherein
said first and second side (12, 13) are of different heights, and
said first and said second upper shelves (32, 33) are positioned, in use, at different heights as to a horizontal reference plane, in a predetermined non-zero range, so that said two upper shelves are arranged to form among each other a slanting support surface for a protective glass (22).

2. The hybrid type solar panel according to claim 1, wherein said basic structure (20) further comprises a front face (31) configured to provide a fixing area on which to fix a set of photovoltaic strings (15), the first upper shelf (32) and the second upper shelf (33) being raised as to the front face (31) by an identical predetermined height.

3. The hybrid type solar panel according to claim 2, wherein the first upper shelf (32) and the second upper shelf (33) are raised as to the front face (31) by an identical predetermined height arranged for creating at least one separation space (14) comprising an air chamber, between the front face (31) and the protective glass (22), arranged for reducing the thermal dispersions of the hybrid panel (10) towards the outside.

4. The hybrid type solar panel according to claim 3, wherein said separation space (14) is configured to further house, between the front face (31) and the protective glass (22), the photovoltaic strings (15) and one or more layers of insulating material (28).

5. The hybrid type solar panel according to claim 4, wherein the slanting support surface is inclined in a range comprised between 1° and 5° as to the horizontal reference plane.

6. The hybrid type solar panel according to claim 5, wherein said basic structure (20) further comprises, in a lower area thereof and on opposite sides (12, 13), two respective shelves (47, 48) configured to seat at least one or more insulation panels (27), an electrical storage (29) and a container for electric components (23).

7. The hybrid type solar panel according to claim 6, wherein said basic structure (20) further comprises, in a lower area thereof, a plurality of raceways (57) made along the entire length of the solar panel (10), said raceways being configured to anchor a hydraulic manifold (25), an electrical manifold (26), the container for electric components (23), the electrical storage (29), one or more insulation panels (27) and any additional accessories.

8. The hybrid type solar panel according to claim 1, wherein, in case of side by side mounting, in use, of a first hybrid panel (10) and of at least one second hybrid panel (10), the first shelf (32) of the first side (12) is configured to overhang the second shelf (33) of the second side (13), when adjacent, by a predetermined height, and to create a tile shaped slide for rainwater precipitations or for any dirt deposited, over time, on the protective glass (22) of each hybrid type solar panel.

9. The hybrid type solar panel according to claim 8, wherein the difference in height between said first side (12) and said second side (13) is comprised between 2-7 mm, and wherein said side by side mounting is carried out, in use, with a slant comprised between 10°-90° degrees.

10. The hybrid type solar panel according to claim 1, wherein, in case of side by side mounting, in use, of a first hybrid panel (10) and of at least one second hybrid panel (10), the side by side hybrid type solar panels are configured to create a house roof comprising a plurality of side by side hybrid type solar panels (10) wherein each basic structure (20) comprises, on the two opposite sides (12, 13) of different height, respective supports (52, 53) with inverted “U” profile configured to allow fixing, by way of screws and/or clamps, to roof traverses of a roof and to create a self-supporting watertight roof of a house.

11. The hybrid type solar panel according to claim 10, wherein each basic structure (20) comprises in a side wall (34), associated to the higher side (12), a seat (37) arranged for receiving a lip shaped gasket (39) configured to ensure, in use, a barrier to water infiltrations between the panels mounted side by side and to ensure the creation of a completely watertight self-supporting surface.

12. A hybrid type solar panel (10) characterized in that it comprises a structure arranged to make a photovoltaic panel, a thermal panel, a watertight roof, an electrical storage (29), all integrated into a basic structure (20).

13. The hybrid type solar panel according to claim 12, wherein said basic structure (20) further comprises, in a lower area thereof and on opposite sides (12, 13), two respective shelves (47, 48) configured to seat at least one or more insulation panels (27), the electrical storage (29) and a container for electric components (23).

14. A house roof comprising, mounted side by side, a plurality of hybrid type solar panels (10) comprising respective basic structures (20), characterized in that each basic structure (20) comprises, on two opposite sides (12, 13) of different heights, respective supports (52, 53) with inverted “U” profile configured to allow fastening the solar panels, by way of screws and/or clamps, to roof traverses and to create a self-supporting watertight roof of a house.

15. The house roof according to claim 14, wherein each basic structure (20) comprises in a side wall (34), associated to the highest side (12), a seat (37) arranged for receiving a lip shaped gasket (39) configured to ensure, in use, a barrier to water infiltrations between the panels mounted side by side and to ensure the creation of a completely watertight self-supporting surface.

16. The hybrid type solar panel according to claim 1, wherein the slanting support surface is inclined in a range comprised between 1° and 5° as to the horizontal reference plane.

17. The hybrid type solar panel according to claim 1, wherein said basic structure (20) further comprises, in a lower area thereof and on opposite sides (12, 13), two respective shelves (47, 48) configured to seat at least one or more insulation panels (27), an electrical storage (29) and a container for electric components (23).

18. The hybrid type solar panel according to claim 17, wherein said basic structure (20) further comprises, in a lower area thereof, a plurality of raceways (57) made along the entire length of the solar panel (10), said raceways being configured to anchor a hydraulic manifold (25), an electrical manifold (26), the container for electric components (23), the electrical storage (29), one or more insulation panels (27) and any additional accessories.

19. The hybrid type solar panel according to claim 7, wherein, in case of side by side mounting, in use, of a first hybrid panel (10) and of at least one second hybrid panel (10), the first shelf (32) of the first side (12) is configured to overhang the second shelf (33) of the second side (13), when adjacent, by a predetermined height, and to create a tile shaped slide for rainwater precipitations or for any dirt deposited, over time, on the protective glass (22) of each hybrid type solar panel.

20. The hybrid type solar panel according to claim 9, wherein, in case of side by side mounting, in use, of a first hybrid panel (10) and of at least one second hybrid panel (10), the side by side hybrid type solar panels are configured to create a house roof comprising a plurality of side by side hybrid type solar panels (10) wherein each basic structure (20) comprises, on the two opposite sides (12, 13) of different height, respective supports (52, 53) with inverted “U” profile configured to allow fixing, by way of screws and/or clamps, to roof traverses of a roof and to create a self-supporting watertight roof of a house.
